(19) United States
(12) Patent Application Publication
(10) Pub. No.: US 2013/0332188 A1
(43) Pub. Date: Dec. 12, 2013

(54) MANAGING PATIENT CARE THROUGH AN EMERGENCY ROOM OF A HOSPITAL USING A COMPUTER

(71) Applicant: Emergency Medical Services Corporation, Greenwood Village, CO (US)

(72) Inventor: Nathan Goldfein, Tijeras, NM (US)

(73) Assignee: Emergency Medical Services Corporation, Greenwood Village, CO (US)

(21) Appl. No.: 13/968,155

(22) Filed: Aug. 15, 2013

Related U.S. Application Data
(63) Continuation-in-part of application No. 13/598,558, filed on Aug. 29, 2012.
Application No. 13/598,558 is a continuation of application No. 12/840,078, filed on Jul. 20, 2010.
(60) Provisional application No. 61/226,986, filed on Jul. 20, 2009.

(51) Int. Cl. G06F 19/00

(52) U.S. Cl. CPC G06F 19/345
USPC 705/2

(57) ABSTRACT

Computer implemented methods of, and apparatuses for, managing patient care through an emergency department of a hospital. Healthcare practitioners are prompted through a computer for a medical diagnosis from a list of diagnoses, for patient conditions pertinent to the diagnosis, and for treatment orders, which can include a medical or medication prescription. The system determines whether sufficient patient conditions have been evaluated to support third party payment for admitting the patient to the hospital if so ordered, automatically contacts an in-patient care practitioner at the hospital, and initiates a process to find a bed for the patient. The practitioner is prompted to issue treatment orders and medication dosages can be automatically checked. Data entered by different practitioners can be compared and shared. Faster and more consistent patient care can be achieved and healthcare costs that are not reimbursed can be minimized.

### RELATED PATENT APPLICATIONS

This patent application is a continuation-in-part of, and claims priority to, U.S. non-provisional patent application Ser. No. 13/598,558, filed on Aug. 29, 2012, titled: Electronic Physician Order Sheet, which is a continuation of U.S. non-provisional patent application Ser. No. 12/840,078, filed on Jul. 20, 2010, also titled: Electronic Physician Order Sheet, which claims priority to U.S. provisional patent application No. 61/226,986 filed on Jul. 20, 2009, all of which have the same inventor as the current patent application and the same assignee, and the contents of all of which are incorporated herein by reference.

### FIELD OF THE INVENTION

This invention relates to computer systems and computer implemented methods for managing patient care through emergency departments of hospitals.

### BACKGROUND OF THE INVENTION

Healthcare practitioners, such as physicians, typically examine a patient to form a diagnosis, and then order treatment and medication based on the diagnosis. As such, physician's efforts have often centered on writing down the orders for treatment and medication. This can lead to a variety of problems wherein a time-constrained physician unintentionally omits things, writes illegibly, or writes the wrong things. Another problem that arises is that the physician's focus is shifted away from diagnosing health issues. This can result in only one primary issue being diagnosed and other issues being missed or ignored. Systems and methods for streamlining the process of providing proper care are needed. Ideally, the systems and processes will encourage physicians and other healthcare practitioners to focus on diagnosis and patient care. Furthermore, the systems and methods can detect and prevent treatment and medication scenarios that may be harmful to the patient.

Room for improvement exists over the prior art in these and other areas that may be apparent to a person of ordinary skill in the art having studied this document.

### SUMMARY OF PARTICULAR EMBODIMENTS OF THE INVENTION

This invention provides, among other things, computer systems or apparatuses and computer implemented methods for managing patient care through emergency departments of hospitals.

Certain aspects of the embodiments address limitations and flaws in the prior art by providing an electronic physician order sheet coupled with algorithmic means for suggesting treatments and medications, for instance. Furthermore, in some embodiments, the algorithmic means can alert physicians and care givers to scenarios that may result in patient harm.

It is an aspect of some embodiments that a presentation device, such as a tablet computer, presents a physician, for example, with input/output fields for diagnosis, treatment, and medication, as examples. A diagnosis field can include a number of suggested diagnoses, for instance. Suggested diagnoses are typically those diagnoses that are commonly encountered or for which the treatments and medications are well understood, in a number of embodiments. The physician, for example, in some embodiments, can make a diagnosis by selecting one or more of the suggested diagnoses. In some embodiments, it is a further aspect of that a logic module or one or more other modules receives the diagnosis and suggests a medication, an order for treatment, or both. The order and medication suggestions are passed back to the presentation device, in some embodiments, such that the physician can select any of the suggested orders and medications.

It is another aspect of certain embodiments to provide a selection means, such as a touch sensitive display, a touch/signature pad, a mouse, a biometric reader, or another device that the healthcare practitioner or physician can use to select any of the suggested medications and orders. The physician, for example, can also use the selection means or a different device to sign or otherwise authenticate the medications and treatments orders that are selected, in some embodiments. The signing or authorization step is necessary, in a number of embodiments, because it transforms the selected medications and selected orders into the ordered medications and the physician's orders that are actually obeyed to thereby treat the patient.

Various embodiments provide, for example, as an object or benefit, that they partially or fully address or satisfy one or more of the needs, potential areas for benefit, or opportunities for improvement described herein, or known in the art, as examples.

Specific embodiments of the invention provide various computer implemented methods of managing patient care through an emergency department of a hospital. In a number of embodiments, such methods include machine-readable instructions that, when executed, perform (e.g., in the order listed here or in another order), at least certain acts. In some embodiments, for example, such acts can include using the computer, prompting an emergency department healthcare practitioner to select at least one of several common medical diagnoses for a patient, forming an ED-identified diagnosis. In a number of embodiments, for each of the several common medical diagnoses, when selected by the emergency department healthcare practitioner to form the ED-identified diagnosis, the method also includes an act of prompting the emergency department healthcare practitioner to select or enter multiple patient conditions that are pertinent to the ED-identified diagnosis, wherein the multiple patient conditions that are entered or selected by the emergency department healthcare practitioner are ED-observed patient conditions. In various embodiments, the prompting of the emergency department healthcare practitioner to select or enter the multiple patient conditions that are pertinent to the ED-identified diagnosis: reminds the emergency department healthcare practitioner to measure or evaluate the multiple patient conditions that are pertinent to the ED-identified diagnosis for assurance of quality patient care, establishes a record of the ED-observed patient conditions for future reference for care of the patient, and increases probability that sufficient patient conditions are evaluated and recorded to support third-party payment for treatment of the ED-identified diagnosis.

Further, in some embodiments, for each of the several common medical diagnoses, when selected by the emergency department healthcare practitioner as the ED-identified diagnosis, the method further includes prompting the emergency department healthcare practitioner to select or enter ED treatment orders for the ED-identified diagnosis. Moreover, in a number of embodiments, for multiple of the several common medical diagnoses, the prompting of the emergency department healthcare practitioner to select or enter the ED treatment orders for the ED-identified diagnosis includes: prompting the emergency department healthcare practitioner to select or enter an ED medical prescription, and prompting the emergency department healthcare practitioner to select a level of care for the patient in the hospital. Even further, in some embodiments, when the ED treatment orders for the ED-identified diagnosis include admitting the patient to the hospital, the method also includes determining whether sufficient ED-observed patient conditions have been evaluated and recorded to support third-party payment for admitting the patient to the hospital. Further still, in a number of embodiments, if sufficient ED-observed patient conditions have not been evaluated and recorded to support third-party payment for admitting the patient to the hospital, the method includes prompting the emergency department healthcare practitioner to either evaluate and enter sufficient ED-observed patient conditions to support third-party payment for admitting the patient to the hospital or to enter an explanation of why the patient needs to be admitted to the hospital absent the sufficient ED-observed patient conditions to support third-party payment for admitting the patient to the hospital.

In various embodiments, such a method further includes prompting the emergency department healthcare practitioner to issue the ED treatment orders for the ED-identified diagnosis. Further, in a number of embodiments, when the ED treatment orders for the ED-identified diagnosis include admitting the patient to the hospital, and the emergency department healthcare practitioner has issued the ED treatment orders for the ED-identified diagnosis, the method further includes automatically contacting an in-patient care practitioner at the hospital, through at least one communications network, and advising the in-patient care practitioner of the ED-identified diagnosis and the ED treatment orders. Even further, in some embodiments, when the ED treatment orders for the ED-identified diagnosis include admitting the patient to the hospital, and the emergency department healthcare practitioner has issued the ED treatment orders for the ED-identified diagnosis, the method further includes automatically initiating a process, through at least one communications network, to find a bed for the patient at the hospital.

Moreover, in particular embodiments, when the ED treatment orders for the ED-identified diagnosis include admitting the patient to the hospital, and the emergency department healthcare practitioner has issued the ED treatment orders for the ED-identified diagnosis, the method further includes acts, using the computer, of finding and assigning a bed for the patient based on at least one of the ED-identified diagnosis or the ED-observed patient conditions. Further, in certain embodiments, when the ED treatment orders for the ED-identified diagnosis include admitting the patient to the hospital, and the emergency department healthcare practitioner has issued the ED treatment orders for the ED-identified diagnosis, the method further includes an act of following up at a predetermined time on the process to find the bed for the patient at the hospital. Even further, in particular embodiments the act of automatically initiating the process to find the bed for the patient at the hospital includes automatically contacting a hospital administrator to request the bed, and the act of following up at a predetermined time on the process to find the bed for the patient at the hospital includes automatically contacting a superior of the hospital administrator to request the bed after the predetermined time.

In some embodiments, for a plurality of the several common medical diagnoses, the act of prompting the emergency department healthcare practitioner to select or enter an ED medical prescription includes prompting the emergency department healthcare practitioner to select or enter at least one medical test. Furthermore, in some embodiments, for a plurality of the several common medical diagnoses, the act of prompting the emergency department healthcare practitioner to select or enter an ED medical prescription includes prompting the emergency department healthcare practitioner to select or enter an ED medication prescription. Further still, in some embodiments, the method further includes an act of prompting the emergency department healthcare practitioner to select the ED medication prescription from multiple medication alternatives, wherein the multiple medication alternatives are each commonly prescribed for the ED-identified diagnosis. Even further still, in certain embodiments, the method further include an act of prompting the emergency department healthcare practitioner to select the ED medication prescription from multiple medication alternatives, wherein the multiple medication alternatives are each hospital-preferred medications for the ED-identified diagnosis. Still further, in some embodiments, such a method can include (e.g., at least one of): suggesting to the emergency department healthcare practitioner a dosage for the ED medication prescription or for each of the multiple medication alternatives, or prompting the emergency department healthcare practitioner to select or enter a dosage for the ED medication prescription, evaluating whether the dosage selected or entered by the emergency department healthcare practitioner for the ED medication prescription is within a recommended dosage range for the ED medication prescription, and alerting if the dosage entered by the emergency department healthcare practitioner for the ED medication prescription is not within the recommended dosage range for the ED medication prescription.

Further, in some embodiments, the method further includes acts of: prompting the emergency department healthcare practitioner to select or enter a body weight of the patient, automatically calculating a dosage or a dosage range for the ED medication prescription or for the multiple medication alternatives using the body weight of the patient, and communicating the dosage or the dosage range for the ED medication prescription or for the multiple medication alternatives to the emergency department healthcare practitioner for use in determining the ED treatment orders for the ED-identified diagnosis. Even further, in some embodiments, the method further includes acts of: using the computer, identifying other medications that the patient is taking, automatically checking for risk of negative interactions between the other medications that the patient is taking and the ED medication prescription or the multiple medication alternatives, and alerting if the risk of negative interactions between the other medications that the patient is taking and the ED medication prescription or the multiple medication alternatives is considered to be excessive. Moreover, in particular embodiments, when the ED treatment orders for the ED-identified diagnosis include admitting the patient to the hospital and administering the ED medication prescription, and the emergency department healthcare practitioner has issued the ED treatment orders for the ED-identified diagnosis, the method further includes an act of automatically communicating the ED medication prescription to a pharmacy for the hospital.

In particular embodiments, when the ED treatment orders for the ED-identified diagnosis include admitting the patient to the hospital, and the emergency department healthcare practitioner has issued the ED treatment orders for the ED-identified diagnosis, the act of automatically contacting the in-patient care practitioner at the hospital further includes advising the in-patient care practitioner of the ED-observed patient conditions selected or entered by the emergency department healthcare practitioner.

In certain embodiments, when the ED treatment orders for the ED-identified diagnosis includes admitting the patient to the hospital, and the emergency department healthcare practitioner has issued the ED treatment orders for the ED-identified diagnosis, the method further includes: prompting the in-patient care practitioner to select at least one of the several common medical diagnoses, forming an IP-identified diagnosis, and for each of the several common medical diagnoses, when selected by the in-patient care practitioner as the IP-identified diagnosis, prompting the in-patient care practitioner to select or enter multiple patient conditions that are pertinent to the IP-identified diagnosis, wherein the multiple patient conditions that are entered or selected by the in-patient care practitioner are IP-observed patient conditions. In a number of such embodiments, the prompting of the in-patient care practitioner to select or enter the multiple patient conditions that are pertinent to the IP-identified diagnosis: reminds the in-patient care practitioner to measure or evaluate the multiple patient conditions that are pertinent to the IP-identified diagnosis for assurance of quality patient care, establishes a record of the IP-observed patient conditions for future reference for care of the patient, and increases probability that sufficient patient conditions are evaluated and recorded to support third-party payment for treatment of the IP-identified diagnosis.

Further, in many such embodiments, for each of the several common medical diagnoses, when selected by the in-patient care practitioner as the IP-identified diagnosis, the method further includes prompting the in-patient care practitioner to select or enter in-patient care practitioner treatment orders for the IP-identified diagnosis. In a number of these embodiments, for multiple of the several common medical diagnoses, the prompting of the in-patient care practitioner to select or enter the in-patient care practitioner treatment orders for the IP-identified diagnosis includes prompting the in-patient care practitioner to select or enter an in-patient care practitioner medical prescription. Even further, some such embodiments further include determining whether sufficient patient conditions have been evaluated and recorded to support third-party payment for admitting the patient to the hospital, and if sufficient patient conditions have not been evaluated and recorded to support third-party payment for admitting the patient to the hospital, prompting the in-patient care practitioner to either evaluate and enter sufficient patient conditions to support third-party payment for admitting the patient to the hospital or to enter an explanation of why the patient needed to be admitted to the hospital absent sufficient patient conditions to support third-party payment for admitting the patient to the hospital. In some embodiments, such a method can further include an act of prompting the in-patient care practitioner to issue the in-patient care practitioner treatment orders for the IP-identified diagnosis.

In particular embodiments, such a method can further include acts of: automatically comparing the IP-identified diagnosis to the ED-identified diagnosis and alerting if the IP-identified diagnosis is sufficiently different than the ED-identified diagnosis. Further, in some embodiments, the method can further include acts of: automatically comparing the IP-observed patient conditions to the ED-observed patient conditions and alerting if the IP-observed patient conditions are sufficiently different than the ED-observed patient conditions. Even further, in some embodiments, the prompting of the emergency department healthcare practitioner to select or enter the multiple patient conditions that are pertinent to the ED-identified diagnosis establishes a standard of care for evaluation of the multiple patient conditions in the emergency department for the ED-identified diagnosis.

Still other specific embodiments of the invention provide various apparatuses for managing patient care through at least one emergency department of at least one hospital. Such an apparatus can include, for example, at least one computer containing machine-readable instructions that can include a list of several common medical diagnoses for presentation to an emergency department healthcare practitioner, and for each of the several common medical diagnoses, a list of multiple pertinent patient conditions for presentation to the emergency department healthcare practitioner wherein evaluation and documentation of the multiple pertinent patient conditions for each of the medical diagnoses can support third-party payment for treatment thereof. Further, such an apparatus or such machine-readable instructions can include, for each of the several common medical diagnoses, a list of alternative medication prescriptions for each of the several common medical diagnoses for presentation to the emergency department healthcare practitioner.

Further, in various embodiments, such an apparatus or such machine-readable instructions can include a medical diagnosis module that presents the list of several common medical diagnoses to the emergency department healthcare practitioner and that inputs from the emergency department healthcare practitioner an ED-identified diagnosis. Even further, in a number of embodiments, such an apparatus or such machine-readable instructions can include a patient conditions module that presents the list of multiple pertinent patient conditions to the emergency department healthcare practitioner for the ED-identified diagnosis after the emergency department healthcare practitioner has input the ED-identified diagnosis into the medical diagnosis module. In various embodiments, the patient conditions module inputs from the emergency department healthcare practitioner the multiple pertinent patient conditions for the ED-identified diagnosis. Further still, in many embodiments, such an apparatus or such machine-readable instructions can include an ED treatment order module that presents the list of alternative medication prescriptions to the emergency department healthcare practitioner for the ED-identified diagnosis after the emergency department healthcare practitioner has input the ED-identified diagnosis into the medical diagnosis module.

In various embodiments, the ED treatment order module prompts the emergency department healthcare practitioner for selection between the alternative medication prescriptions, the ED treatment order module inputs from the emergency department healthcare practitioner ED treatment orders for the ED-identified diagnosis, or both. Further, in a number of embodiments, the ED treatment orders includes an ED medication order indicating whether or not to administer a selection from the list of alternative medication prescriptions, the ED treatment orders input from the emergency department healthcare practitioner through the ED treatment order module include an admission order indicating whether or not to admit the patient to the hospital for the ED-identified diagnosis, or both.

Further, in a number of embodiments, such an apparatus or such machine-readable instructions can include an admissions criteria verification module which, when the ED treatment orders for the ED-identified diagnosis include admitting the patient to the hospital, evaluates whether sufficient ED-observed patient conditions have been evaluated and recorded to support third-party payment for admitting the patient to the hospital, and if sufficient ED-observed patient conditions have not been evaluated and recorded to support third-party payment for admitting the patient to the hospital, that prompts the emergency department healthcare practitioner to evaluate and enter sufficient ED-observed patient conditions to support third-party payment for admitting the patient to the hospital or to enter an explanation of why the patient needs to be admitted to the hospital absent sufficient ED-observed patient conditions to support third-party payment for admitting the patient to the hospital. Even further, in a number of embodiments, such an apparatus or such machine-readable instructions can include an ED treatment order issuance module that provides for the emergency department healthcare practitioner to issue the ED treatment orders for the ED-identified diagnosis.

Further still, in a number of embodiments, such an apparatus or such machine-readable instructions can include a an ED treatment implementation module that, when the ED treatment orders for the ED-identified diagnosis include admitting the patient to the hospital, and the emergency department healthcare practitioner has issued the ED treatment orders for the ED-identified diagnosis through the ED treatment order issuance module, automatically contacts a in-patient care practitioner at the hospital, through at least one communications network, and advises the in-patient care practitioner of the ED-identified diagnosis and the ED treatment orders. Even further still, in some embodiments, the ED treatment implementation module automatically initiates a process to find a bed for the patient at the hospital.

In particular embodiments, when the ED treatment orders for the ED-identified diagnosis include admitting the patient to the hospital, and the emergency department healthcare practitioner has issued the ED treatment orders for the ED-identified diagnosis through the ED treatment order issuance module, the ED treatment implementation module also follows up at a predetermined time on the process to find the bed for the patient at the hospital. Further, in certain embodiments, the ED treatment order module suggests to the emergency department healthcare practitioner a dosage for the ED medication order or for each of the alternative medication prescriptions for use in the ED treatment orders for the ED-identified diagnosis.

In addition, various other embodiments of the invention are also described herein, and various benefits of certain embodiments may be apparent to a person of ordinary skill in the art.

### BRIEF DESCRIPTION OF THE DRAWINGS

The accompanying figures, in which like reference numerals refer to identical or functionally similar elements throughout the separate views and which are incorporated in and form a part of the specification, further illustrate various examples of the present invention and, together with the written description, serve to explain the principles of certain embodiments of examples of the present invention.

FIG. 1 is a block diagram illustrating an example of a system for entering or selecting diagnoses, entering or selecting treatments, entering or selecting medications, and authorizing selections, in accordance with aspects of certain embodiments;

FIG. 2 is a block diagram illustrating an example of a system wherein a provider offers electronic physician's order sheets as a service in accordance with aspects of some embodiments;

FIG. 3 is a block diagram illustrating an example of a system that includes an alarm module that detects scenarios that can result in patient harm, in accordance with aspects of some embodiments;

FIG. 4 is a high level flow diagram illustrating a method of (e.g., a physician) using an electronic physicians order sheet in accordance with aspects of particular embodiments;

FIG. 5 is a high level flow diagram illustrating a computer implemented method of managing patient care through an emergency department of a hospital; and

FIG. 6 is a block diagram illustrating an apparatus for managing patient care through at least one emergency department of at least one hospital.

These drawings illustrate, among other things, examples of certain aspects of particular embodiments of the invention. Other embodiments may differ. Various embodiments may include aspects shown in the drawings, described in the specification, shown or described in other documents that are incorporated by reference, known in the art, or a combination thereof, as examples.

### DETAILED DESCRIPTION OF EXAMPLES OF EMBODIMENTS

A number of embodiments of the subject matter described herein include various examples of computer systems and computer implemented methods for managing patient care through emergency departments of hospitals. The particular values and configurations discussed in these non-limiting examples can be varied and are cited merely to illustrate embodiments and are not intended to limit the scope of the invention.

In certain embodiments, an electronic physician's order sheet (EPOS) provides means for a physician to select or enter diagnoses and to automatically receive suggestions for medications and treatments. The physician can select from amongst the suggestions, in a number of embodiments, select alternate medications and treatments, or input and select different medications or treatments, for example. The EPOS can alert the physician to possible drug interactions, allergic reactions, or other alarming situations, in some embodiments. The physician can then sign the EPOS to formally issue orders for treatment and medications in various embodiments. In certain embodiments, the EPOS can be integrated with billing systems, pharmacy systems, and other systems to help automate the processes of drug delivery, invoicing, and patient care, as examples.

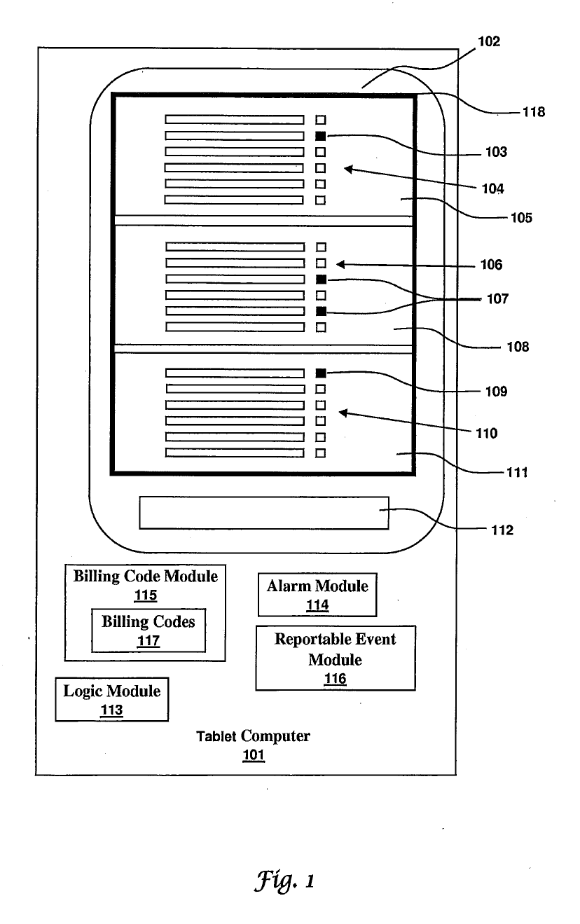

FIG. 1 illustrates an example of a system for entering or selecting diagnoses, entering or selecting treatments, entering or selecting medications, and authorizing selections, in accordance with aspects of certain embodiments. A tablet computer 101 can have a presentation device 102, a processor, memory, and input devices, for instance. An input device can be a pen input device, a track pad, a mouse interface, a touch sensitive screen, or other device. The presentation device 102 can be a flat panel display, for example.

In the embodiment illustrated, the presentation device 102 can present a graphical user interface (GUI) to a physician, for instance. The GUI can include, in some embodiments, a diagnoses field 105, an order field 108, a medication field 111, and an alert or alarm indicator 118, for example. In the example shown, the alarm indicator is a heavy frame around the other fields, colored red, for instance, which appears when the alarm module 114 has detected an alarm situation. Other embodiments for alarms are sounds or the highlighting of specific elements in the fields to indicate what is causing the alarm, as examples.

In the embodiment depicted, the diagnoses field 105 can include a number of suggested diagnoses 104. The order field can present a number of possible orders 106 and the medication field can present a number of possible medications. In the example illustrated, the physician has chosen one of the diagnoses as a selected diagnosis 103. The logic module 113 receives the selected diagnosis 103 and suggests two treatments as order suggestions 107 and one of the medications as a medication suggestion 109. In some embodiments, the physician can clear a suggestion, select alternatives, or opt to do nothing in which case the suggestions automatically become the physician's selections.

In a number of embodiments, the physician can authenticate or issue the selections by signing on a signature pad 112. In the embodiment shown, the physician's authentication transforms the selections into actual physician's orders for treatments to be performed and into ordered medications to be administered.

In certain embodiments, the reportable events module 116 detects events that must be reported to authorities. Gun shot wounds, certain infectious diseases, and child abuse are examples of reportable events. The reportable events module can alert the physician, in various embodiments, that an event must be reported. In some embodiments, the EPOS can directly and immediately report the event to the proper authorities.

In particular embodiments, the billing code module 115 can associate billing codes 117 with the possible orders 106, selected orders 107, possible medications 110, selected medications 109, physician's orders, and medication orders. Many medical treatment facilities currently employ people to attach billing codes to physician's orders and medication orders. The billing code module alleviates the need for such personnel, in some embodiments.

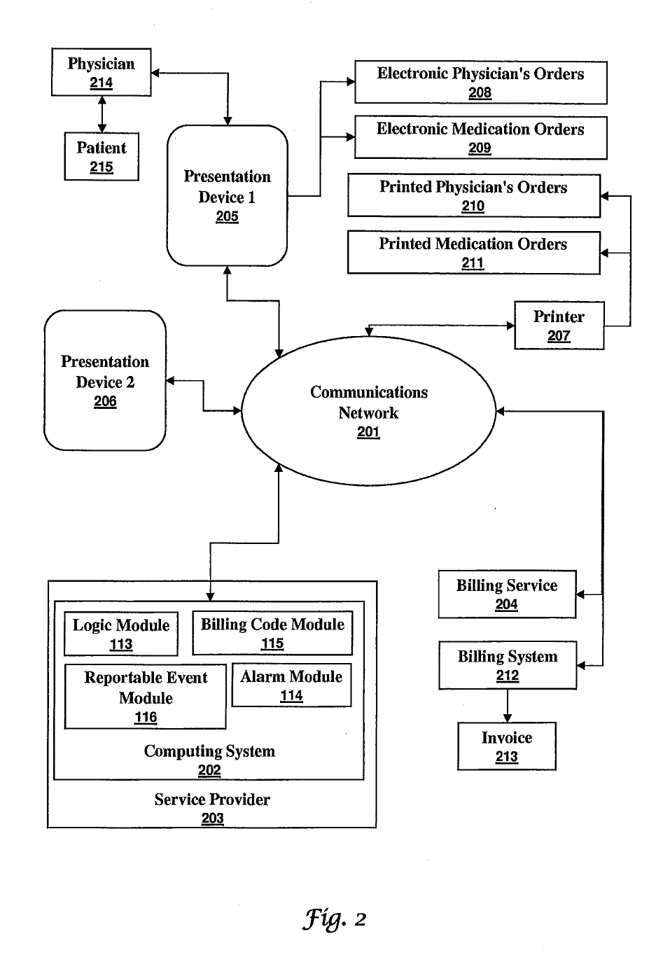

FIG. 2 illustrates an example of a service provider 203 offering electronic physician's order sheets as a service in accordance with aspects of some embodiments. The service provider 203 provides and services a computing system 202 that is connected to a communications network 201 such as the Internet, a phone network, a wireless network, or another communications fabric. The computing system 202 can include the logic module 113, the billing code module 115, the reportable events module 116, and the alarm module 114, as examples.

In some embodiments, other systems, services, and devices such as presentation device 1 205, presentation device 2 206, printer 207, billing service 204, and billing system 212 are connected to communications network and can use it to communicate with each other and with the computing system 202 of the service provider 203.

A physician 214 is shown, for example, using presentation device 1 205 to produce physician's orders and medication orders for the treatment of a patient 215. The orders issued from presentation device 1 205 are initially electronic physician's orders 208 and electronic medication orders 209. Electronic orders, when properly authenticated, can be obeyed in some health care facilities. The orders can be printed by a printer 207, for example, to produce printed physician's orders 210 and printed medication orders 211. The physician 214 can physically sign the printed orders 210, 211, in some embodiments.

In particular embodiments, the orders can (e.g., also) be transmitted to a billing service 204 and/or a billing system 212, for example. A billing system 212 can be, for example, a system that generates and tracks invoices 213 to ensure that a health care provider is compensated for providing care. A billing service 204 can be, in some embodiments, a company under contract to a health care provider to generate invoices and, in certain embodiments, to collect invoice payments.

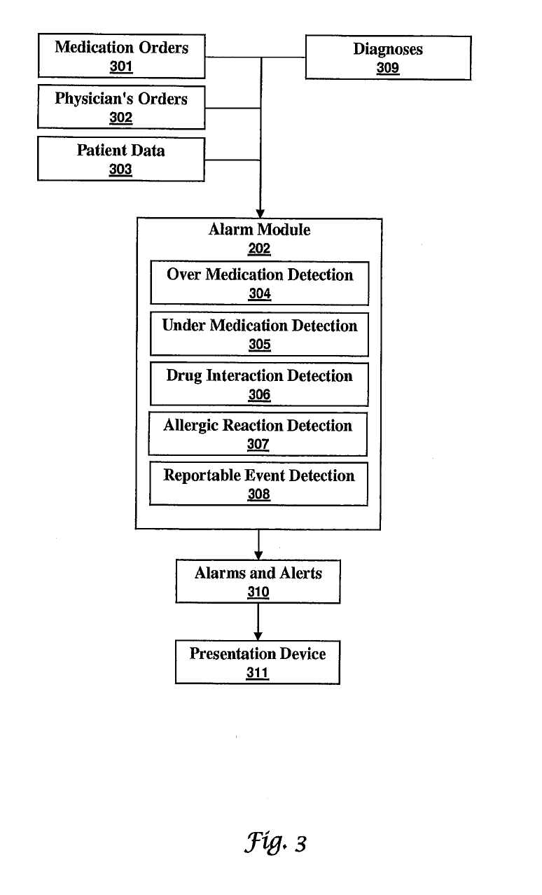

FIG. 3 illustrates an example of an alarm module 202 that detects scenarios that can result in patient harm, in accordance with aspects of some embodiments. Medication orders 301, physician's orders 302, patient data 303, and diagnoses 309 can be input into the alarm module 202, for instance. The patient data 303 can be obtained during the patient intake process, for example, during the course of treatment, or from previously obtained or produced medical records, as examples. The alarm module 202 can detect conditions or scenarios that can harm the patient such as over medication 304, under medication 305, drug interaction 306, and allergic reaction 307, for instance. The alarm module 202 can also function as a reportable event module, in some embodiments, by detecting reportable events 308. Upon detection, the alarm module 202 can produce alarms and/or alerts 310 and submit them to a presentation device 311, for instance. The presentation device 311 can be the very same device that a physician is using to submit diagnoses 309, can be a different device, or can be multiple devices, as examples.

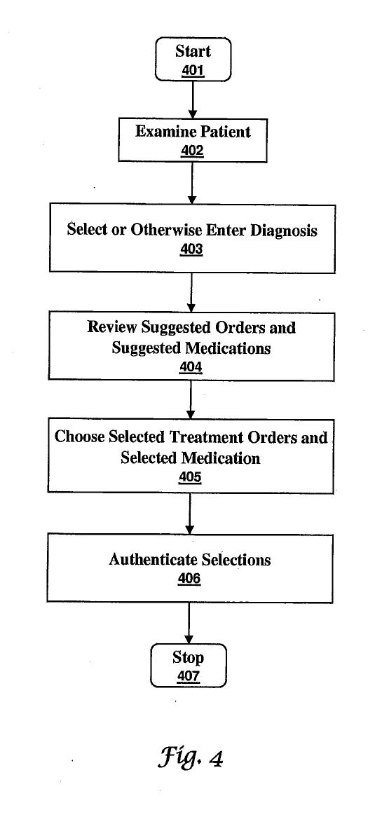

FIG. 4 illustrates an example of a high level flow diagram of a healthcare practitioner, such as a physician using an electronic physicians order sheet in accordance with aspects of certain embodiments. After the start 401, the physician examines a patient 402 and selects or otherwise enters diagnoses 403, in this example. The logic module then suggests treatment orders (aka order suggestions) and medication (medication orders) 404. The physician reviews the suggested orders and the suggested medications 404. If the suggestions are not what the physician wants, then other options can be selected (via checkbox, menu, etc.) or otherwise entered into the EPOS, in various embodiments. In a number of embodiments, the desired treatments and medications are selected 405. The physician then authenticates the selections 406, in the embodiment illustrated, so that the appropriate orders are issued to caregivers, such as nurses, and to the pharmacy that provides the medications used to treat the patient, as examples. At this point, the process stops 407, at least until the physician again examines the patient 402.

A number of embodiments can be implemented in the context of modules. In the computer programming arts, a module can be typically implemented as a collection of routines and data structures that performs particular tasks or implements a particular abstract data type. Modules generally can be composed of two parts. First, a software module may list the constants, data types, variable, routines and the like that that can be accessed by other modules or routines. Second, a software module can be configured as an implementation, which can be private (i.e., accessible perhaps only to the module), and that contains the code that actually implements the routines or subroutines upon which the module is based. Thus, for example, the term module, as utilized herein, generally refers to software modules or implementations thereof. Such modules can be utilized separately or together to form a program product that can be implemented through signal-bearing media, including transmission media and recordable media. Although different modules are described herein, in a number of embodiments, some computer code can be used in different modules, different modules can be combined into the same block of code, certain modules can be made up of different blocks of code, or a combination thereof.

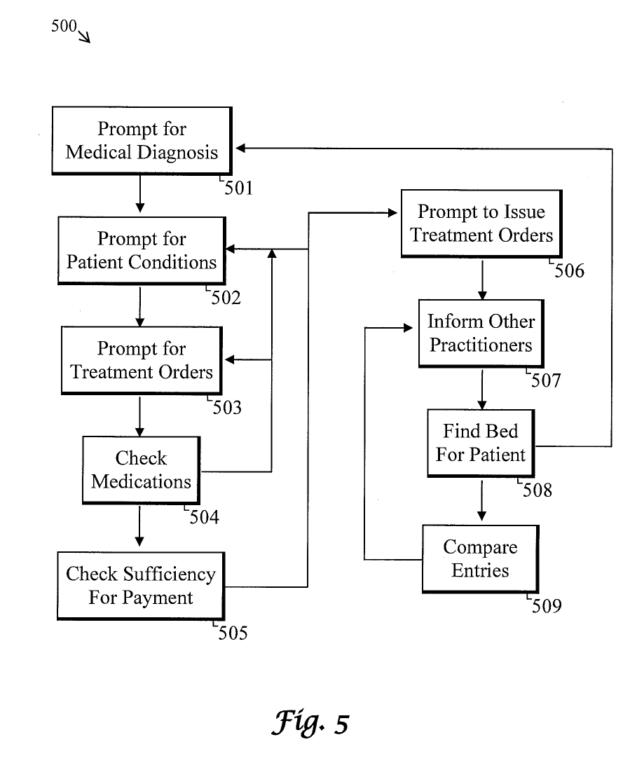

FIG. 5 illustrates an example of a computer implemented method, method 500, of managing patient care through an emergency department of a hospital. A patient may enter or be delivered to the emergency department of the hospital to be seen by an emergency department healthcare practitioner for a particular condition. In many cases, it may be prudent to admit the patient to the hospital, and the emergency department healthcare practitioner may determine, or be involved in the decision as to, whether to admit the patient to the hospital. In some embodiments, the emergency department healthcare practitioner identifies patients that may be admitted to the hospital. In different embodiments, method 500, or a similar computer-implemented method, can be used for all patients entering the emergency department or just for patients that the emergency department healthcare practitioner identifies for potential admission to the hospital. In a number of embodiments, method 500, or a similar computer-implemented method, can be used to assist with admission criteria. In various embodiments, method 500, or a similar computer-implemented method, can utilize InterQual, InterQual criteria, evidence-based medicine, measurable, clinical indicators, a diagnosis, the level of illness of the patient, the services required, or a combination thereof, as examples.

In some embodiments, the emergency department healthcare practitioner may decide to use method 500, or a similar computer-implemented method for some patients, but not for others. In certain embodiments, the emergency department healthcare practitioner discusses the patient (e.g., in person or by phone) with an in-patient care practitioner, for instance, concerning whether to use method 500, or a similar computer-implemented method for a particular patient. In some embodiments, if the emergency department healthcare practitioner and the in-patient care practitioner agree that a particular patient is not a candidate for method 500, or a similar computer-implemented method for a particular patient, or if the emergency department healthcare practitioner makes such a decision without consultation with the in-patient care practitioner, the patient may be discharged or transferred to another facility, as examples.

In the example shown, method 500 includes machine-readable instructions that, when executed, perform (e.g., in the order shown in FIG. 5 or in another order), at least certain acts. In the embodiment shown, for example, such acts include, using the computer, act 501 of prompting the emergency department healthcare practitioner to select at least one of several common medical diagnoses for a particular patient. As used herein, the medical diagnosis selected or entered by the emergency department healthcare practitioner is called an ED-identified diagnosis. In certain embodiments, the common medical diagnoses can include, for example, chest pain, pneumonia, congestive heart failure, COPD, Ileus, obstruction, CVA, severe chronic anemia, diverticulitis, pyelonephritis, or a combination thereof. Different embodiments can have a longer or shorter list of common medical diagnoses. Further, in a number of embodiments the healthcare practitioner is given the option to enter another diagnosis besides the common medical diagnoses, if appropriate.

In a number of embodiments, a healthcare practitioner, such as an emergency department healthcare practitioner or an in-patient care practitioner can be, as examples, a physician, a physician's assistant, a certified nurse practitioner, or a registered nurse, for instance. In other embodiments, a healthcare practitioner can be, as further examples, an advanced practice registered nurse, a licensed practical nurse, a chiropractor, a dentist, a pharmacist, a clinical pharmacist, a licensed midwife, a certified nurse midwife, a dietitian, a therapist, a psychologist, a clinical officer, a phlebotomist, a physical therapist, a respiratory therapist, an occupational therapist, an audiologist, a speech pathologist, an optometrist, an emergency medical technician, a paramedic, a medical laboratory scientist, a medical prosthetic technician, a radiographer, a social worker, or another professional trained to provide a health care service.

In the embodiment shown, for each of the several common medical diagnoses prompted in act 501, when selected by the emergency department healthcare practitioner to form the ED-identified diagnosis, method 500 also includes act 502 of prompting the emergency department healthcare practitioner to select or enter multiple patient conditions that are pertinent to the ED-identified diagnosis. As used herein, the multiple patient conditions that are entered or selected by the emergency department healthcare practitioner (e.g., in act 502) can be referred to as ED-observed patient conditions. In various embodiments, the prompting of the emergency department healthcare practitioner to select or enter the multiple patient conditions that are pertinent to the ED-identified diagnosis (e.g., in act 502): reminds the emergency department healthcare practitioner to measure or evaluate the multiple patient conditions that are pertinent to the ED-identified diagnosis for assurance of quality patient care, establishes a record of the ED-observed patient conditions for future reference for care of the patient, and increases probability that sufficient patient conditions are evaluated and recorded to support third-party payment for treatment of the ED-identified diagnosis. Third-party payment can be payment from an insurance company or from a governmental agency or program, as examples. Once prompted in act 502, the practitioner may record observations already made, examine the patient, order tests, enter the patient conditions into the computer, or a combination thereof, for example. Observation of patient conditions, in a number of embodiments, can confirm a diagnosis, rule out a diagnosis (e.g., a main diagnosis or an alternative diagnosis), identify or suggest other diagnoses, narrow a diagnosis, indicate how severe a diagnosed condition is, suggest a specific treatment, or a combination thereof, as examples.

Examples of the multiple patient conditions (e.g., prompted in act 502) that are pertinent to the ED-identified diagnosis include, for example, for a diagnosis of chest pain, patient conditions of: pulse rate, SBP, respiratory rate, history of pain, labs, including biomarkers, hemoglobin, HA1C, TSH, EKG characteristics, age of the patient, whether the patient is taking aspirin, whether the patient has chronic kidney disease or diabetes, whether the patient is a current or past smoker, whether the patient has a family history of CAD, whether the patient is on any antihypertensive meds, and whether the patient has hyperlipidemia. For some of the multiple patient conditions, the healthcare practitioner can be prompted (e.g., in act 502) to indicate whether the patient is above or below a threshold (e.g., whether pulse rate is greater than 120, whether SBP is less than 90, whether respiratory rate is greater than 29, or a combination thereof).

Even further, in some embodiments, the prompting of the emergency department healthcare practitioner to select or enter the multiple patient conditions that are pertinent to the ED-identified diagnosis (e.g., act 502) establishes a standard of care for evaluation of the multiple patient conditions in the emergency department for the ED-identified diagnosis. Thus, in a number of embodiments, if the emergency department healthcare practitioner evaluates all of the multiple patient conditions that are identified in act 502, then the emergency department healthcare practitioner will have done what is expected of him in the emergency department for that ED-identified diagnosis. Further, in various embodiments, the emergency department healthcare practitioner entering such patient conditions into the system or apparatus provides evidence that the emergency department healthcare practitioner did what was expected of him in the emergency department for that ED-identified diagnosis. On the other hand, if the emergency department healthcare practitioner does not evaluate all of the multiple patient conditions that are identified in act 502, then, at least in some embodiments, the emergency department healthcare practitioner will not have done what is expected of him in the emergency department for that ED-identified diagnosis, and the record will so indicate. Further, the hospital or other entity in control of the system can control the level of care provided by different healthcare practitioners, can make adjustments when appropriate, and the level of care can be more consistent between different healthcare practitioners.

Further, in the embodiment depicted, for each of the several common medical diagnoses (e.g., prompted in act 501), when selected by the emergency department healthcare practitioner as the ED-identified diagnosis, method 500 further includes act 503 of prompting the emergency department healthcare practitioner to select or enter ED treatment orders, for example, for the ED-identified diagnosis. Moreover, in a number of embodiments, for multiple of the several common medical diagnoses (e.g., prompted in act 501), the prompting (e.g., in act 503) of the emergency department healthcare practitioner to select or enter the ED treatment orders for the ED-identified diagnosis includes: prompting the emergency department healthcare practitioner to select or enter an ED medical prescription, prompting the emergency department healthcare practitioner to select a level of care for the patient in the hospital, or both. In various embodiments, a medical prescription can be or include the administration of one or more medications, medical tests, medical treatments, or a combination thereof, as examples. Further, in various embodiments, a level of care for the patient in the hospital can be: admitting the patient to the hospital, observing the patient without admitting the patient to the hospital, or discharging the patient, as examples. In a number of embodiments where the patient is discharged, follow up care can be prescribed, for instance, as part of a medical prescription.

Even further, in the embodiment illustrated, when the ED treatment orders (e.g., prompted for in act 503) for the ED-identified diagnosis (e.g., prompted in act 501 and then selected by the healthcare practitioner) include admitting the patient to the hospital, method 500 also includes act 505 of checking, evaluating, or determining whether sufficient ED-observed patient conditions have been evaluated and recorded to support third-party payment for admitting the patient to the hospital. Further still, in a number of embodiments, including the embodiment shown, if sufficient ED-observed patient conditions have not been evaluated and recorded to support third-party payment for admitting the patient to the hospital, the method (e.g., method 500) includes prompting (e.g., returning to act 502) the emergency department healthcare practitioner to either evaluate and enter sufficient ED-observed patient conditions to support third-party payment for admitting the patient to the hospital or, in some embodiments, to enter an explanation of why the patient needs to be admitted to the hospital absent the sufficient ED-observed patient conditions to support third-party payment for admitting the patient to the hospital. This encourages the practitioner, in a number of embodiments, to enter sufficient information to obtain payment, while allowing the practitioner the option to admit a patient even if the patient does not appear to qualify for payment based on the information available at that time. As a result, in various embodiments, the practitioner has the final word on whether to admit the patient rather than an automated computer system.

In the embodiment illustrated, method 500 further includes act 506 of prompting the emergency department healthcare practitioner to issue the ED treatment orders for the ED-identified diagnosis. Issuing the orders is essentially equivalent to signing the treatment orders, but in a number of embodiments, can be performed electronically by the practitioner (e.g., by clicking on a “issue treatment orders” button. In some embodiments, the keystroke to issue the orders must be confirmed by the practitioner. Further, in some embodiments, the practitioner must enter a code or password to issue orders. In some embodiments, one or more healthcare practitioners with less education or experience may enter information prompted for in acts 501 to 505, and a healthcare practitioner with a greater amount of education or experience, or with decision-making responsibility, may review the entries, see the patient, and if appropriate, issue the orders in act 506. In some embodiments, such tasks may be divided in other ways between different healthcare practitioners.

Further, in a number of embodiments, when the ED treatment orders (e.g., prompted in act 503 to be entered) for the ED-identified diagnosis (e.g., prompted in at 501 to be selected) include admitting the patient to the hospital, and the emergency department healthcare practitioner has issued (e.g., prompted in act 506) the ED treatment orders for the ED-identified diagnosis, the method (e.g., method 500) further includes automatically contacting (e.g., in act 507) the in-patient care practitioner at the hospital, for example, through at least one communications network, and advising the in-patient care practitioner, for instance, of the ED-identified diagnosis and the ED treatment orders. In a number of embodiments, the in-patient care practitioner can be a hospitalist, for example. In other embodiments, the in-patient care practitioner can be one of the other healthcare practitioners identified herein, as other examples. In different embodiments, this communication (e.g., in act 507) can take the form of an e-mail, a text message, a voice mail, a prerecorded or synthesized voice message (e.g., delivered by phone or page), a posting on a website, or a combination thereof, as examples. Further, in some embodiments, more than one in-patient care practitioner can be so contacted (e.g., in act 507). In certain embodiments, the emergency department healthcare practitioner discusses the patient (e.g., in person or by phone) with the in-patient care practitioner(s), for instance, concerning the decision whether to admit the patient to the hospital, the diagnosis, the treatment orders, the patient conditions, medications, or a combination thereof, as examples. In various embodiments, the emergency department healthcare practitioner can request (e.g., in act 507) that the in-patient care practitioner see the patient in the emergency department, for instance, before the patient is admitted to the hospital or assigned or transported to a bed. In some such embodiments, the in-patient care practitioner may see the patient before releasing the patient to be admitted, assigned a bed, transported to the bed, discharged, or otherwise removed from the emergency department. In particular embodiments, this may involve various acts of method 500 (e.g., prompted to the in-patient care practitioner).

In some embodiments, the emergency department healthcare practitioner makes the decision whether to admit the patient to the hospital. In other embodiments, however, the emergency department healthcare practitioner consults with the in-patient care practitioner on the decision whether to admit the patient to the hospital. In particular embodiments, the emergency department healthcare practitioner identifies patients who may need to be admitted, or for which it may be appropriate to admit the patient, and the in-patient care practitioner makes the final decision whether to admit the patient to the hospital or may approve such a decision, as further examples. In some embodiments, the emergency department healthcare practitioner may consult with, or obtain approval from, (e.g., including informing in act 507) the in-patient care practitioner before treatment orders are issued (e.g., in act 506 or a similar act), as another example. In some embodiments, the emergency department healthcare practitioner presses a button or clicks on an icon to have the computer or apparatus contact the in-patient care practitioner (e.g., in act 507), for instance, which, as used herein, is included within the meaning of “automatically” when referring to act 507. In other embodiments, however, another event or act may trigger act 507 or the contacting of the in-patient care practitioner, such as, for example, issuing the orders (e.g., prompted to be issued in act 506).

Even further, in some embodiments, including in the example of method 500, when the ED treatment orders (e.g., prompted to be entered in act 503) for the ED-identified diagnosis (e.g., prompted to be selected in act 501) include admitting the patient to the hospital, and the emergency department healthcare practitioner has issued (e.g., prompted to be issued in act 506) the ED treatment orders for the ED-identified diagnosis, the method further includes automatically initiating a process, through at least one communications network, to find a bed for the patient at the hospital (e.g., act 508). Such a network can be, for example, a computer network, a local area network, a wide area network, the Internet, or a telephone network (e.g., a mobile phone network), as examples. In particular embodiments, when the ED treatment orders (e.g., prompted to be entered in act 503) for the ED-identified diagnosis (e.g., prompted to be selected in act 501) include admitting the patient to the hospital, and the emergency department healthcare practitioner has issued the ED treatment orders for the ED-identified diagnosis (e.g., prompted to be issued in act 506), the method (e.g., 500) further includes (e.g., using the computer) finding and assigning a bed for the patient (e.g., in act 508) based on at least one of: the ED-identified diagnosis (e.g., prompted to be entered in act 501) or the ED-observed patient conditions (e.g., prompted to be entered in act 502). For instance, the gender, age, level of care required, and diagnosis can determine which bed to select for the patient (e.g., in act 508).

In other embodiments, act 508 can involve the computer (e.g., automatically) contacting one or more people (e.g., hospital staff or administrators or case management) to find a bed for the patient, for instance, by sending an e-mail, a text message, a pre-recorded or synthesized voice phone message, a page, or a voice mail, or by making a posting on a website, as examples, or a combination thereof. In certain embodiments, when the ED treatment orders for the ED-identified diagnosis include admitting the patient to the hospital, and the emergency department healthcare practitioner has issued (e.g., prompted in act 506) the ED treatment orders for the ED-identified diagnosis, method 500 further includes (e.g., in act 508) following up, for instance, at a predetermined time, on the process to find the bed for the patient at the hospital. Such a predetermined time can be, for example, a quarter of an hour, a half hour, three quarters of an hour, an hour, an hour and a half, two hours, three hours, or four hours, as examples, or a combination thereof. In particular embodiments, act 508 (e.g., of automatically initiating the process to find the bed for the patient at the hospital) includes automatically contacting a hospital administrator to request the bed, and the act (within act 508) of following up at a predetermined time on the process to find the bed for the patient at the hospital includes automatically contacting a superior of the hospital administrator to request the bed, for instance, after the predetermined time. Such a superior can be, for example, a house supervisor. In such embodiments, automatic escalation to the superior can encourage that a bed is found promptly, promote better patient care, and avoid a pile up of patients in the emergency department that are waiting for a bed, as examples. In addition, such escalation can provide a reliable means of communication up through the chain of command if the hospital is overwhelmed by patients, for example, so appropriate action can be efficiently taken to accommodate the increase in demand.

In some embodiments, once a bed is assigned, the computer or apparatus (e.g., automatically) notifies the transport or ED Unit clerk, the charge nurse, or both (e.g., in act 507). Further, in some embodiments, the computer or apparatus (e.g., automatically) notifies the in-patient care practitioner when the patient arrives at the bed. Even further, in particular embodiments, the emergency department healthcare practitioner, the in-patient care practitioner, a hospital administrator, or a combination thereof, is notified (e.g., automatically) by the computer or apparatus if the patient is not delivered to the bed within a predetermined amount of time. Even further still, in some embodiments, an alert is made (e.g., automatically, for instance, to the in-patient care practitioner, to a hospital administrator, or both) by the computer or apparatus if the in-patient care practitioner does not start to evaluate the patient (e.g., responding to prompts of acts 501-503) or issue treatment orders (e.g., prompted in act 506) within a predetermined time, for example, after the patent is delivered to the bed.

In some embodiments, for a plurality of the several common medical diagnoses (e.g., prompted to be selected in act 501), the act of prompting the emergency department healthcare practitioner to select or enter an ED medical prescription (e.g., in act 503) includes prompting the emergency department healthcare practitioner to select or enter at least one medical test. Examples of medical tests, that may apply for different medical diagnoses, include blood tests, x-rays, an MRI, or an EKG, for instance. Further, in a number of embodiments, at least for a plurality of the several common medical diagnoses, the act of prompting the emergency department healthcare practitioner to select or enter an ED medical prescription (e.g., in act 503) includes prompting the emergency department healthcare practitioner to select or enter an ED medication prescription. Further still, in some embodiments, method 500 further includes (e.g., within act 503) prompting the emergency department healthcare practitioner to select the ED medication prescription from multiple medication alternatives. In a number of embodiments, the multiple medication alternatives are each commonly prescribed for the ED-identified diagnosis. Even further still, in certain embodiments, the multiple medication alternatives are each hospital-preferred medications for the ED-identified diagnosis. In this way, the hospital (or another entity in control of the list of medication alternatives) can guide practitioners to prescribe medications that the hospital (or other entity) has found to be effective, safe, available, cost effective, or a combination thereof, as examples.

Still further, in some embodiments, such a method (e.g., 500) can include (e.g., at least one of): suggesting to the emergency department healthcare practitioner (e.g., in act 503) a dosage for the ED medication prescription or for each of the multiple medication alternatives, or prompting the emergency department healthcare practitioner to select or enter a dosage for the ED medication prescription, evaluating whether the dosage selected or entered by the emergency department healthcare practitioner for the ED medication prescription is within a recommended dosage range for the ED medication prescription, and alerting if the dosage entered by the emergency department healthcare practitioner for the ED medication prescription is not within the recommended dosage range for the ED medication prescription. In a number of embodiments, the (e.g., emergency department) healthcare practitioner can be alerted (e.g., before act 506), and in some embodiments, other practitioners (e.g., the healthcare practitioner's supervisor, the pharmacist, or the nurse) can be alerted (e.g. in act 507), for example, after the healthcare practitioner has issued the treatment orders (e.g. in act 506).

Further, in some embodiments, the method (e.g., 500) further includes prompting the emergency department healthcare practitioner to select or enter a body weight or mass of the patient (e.g., in act 502), automatically calculating a dosage or a dosage range for the ED medication prescription or for the multiple medication alternatives (e.g., in act 504), for instance, using the body weight of the patient, and communicating the dosage or the dosage range for the ED medication prescription or for the multiple medication alternatives to the emergency department healthcare practitioner (e.g., in act 503) for use in determining the ED treatment orders for the ED-identified diagnosis.

Even further, in some embodiments, the method (e.g., 500) further includes, using the computer, identifying other medications that the patient is taking (e.g., in act 504), automatically checking for risk of negative interactions between the other medications that the patient is taking and the ED medication prescription (e.g., prompted to be entered in act 503) or the multiple medication alternatives (e.g., prompted for selection in act 503), and alerting if the risk of negative interactions between the other medications that the patient is taking and the ED medication prescription or the multiple medication alternatives is considered to be excessive. Again, in a number of embodiments, the (e.g., emergency department) healthcare practitioner can be alerted (e.g., before act 506), and in some embodiments, other practitioners (e.g., the healthcare practitioner's supervisor, the pharmacist, or the nurse) can be alerted (e.g. in act 507), for example, after the healthcare practitioner has issued the treatment orders. In a number of embodiments, the other medications that the patient is taking (e.g., other than those medications prompted to be entered in act 503), can be identified (e.g., in act 504) by checking the patient's electronic medical records, by asking the patient or the patient's family members, from paperwork that the patient has been asked to complete, from pharmacy records for the patient, or from blood tests performed on the patient (e.g., prompted for in act 502 or 503), as examples.

Moreover, in particular embodiments, when the ED treatment orders (e.g., prompted for in act 503) for the ED-identified diagnosis (e.g., prompted for selection in act 501) include admitting the patient to the hospital and administering the ED medication prescription, and the emergency department healthcare practitioner has issued the ED treatment orders for the ED-identified diagnosis (e.g., in act 506), the method (e.g., 500) further includes automatically communicating the ED medication prescription to a pharmacy for the hospital (e.g., in act 507). Further, in particular embodiments, when the ED treatment orders (e.g., prompted for in act 503) for the ED-identified diagnosis include admitting the patient to the hospital, and the emergency department healthcare practitioner has issued the ED treatment orders for the ED-identified diagnosis (e.g., pursuant to act 506), the act of automatically contacting the in-patient care practitioner at the hospital (e.g., act 507) further includes advising the in-patient care practitioner of the ED-observed patient conditions selected or entered by the emergency department healthcare practitioner (e.g., prompted for entry in act 507).

In a number of embodiments, (e.g., after act 507, after act 508, or both, at least in certain situations (e.g., when the patient is admitted to the hospital) the in-patient care practitioner takes over the care of the patient and responsibility for the patient from the emergency department healthcare provider. In various embodiments, method 500, portions thereof, or a similar method, may be repeated for, conducted for, or applied to, the in-patient care provider. For example, in certain embodiments, when the ED treatment orders (e.g., prompted to be selected or entered in act 503) for the ED-identified diagnosis (e.g., prompted for selection in act 501) include admitting the patient to the hospital, and the emergency department healthcare practitioner has issued the ED treatment orders for the ED-identified diagnosis (e.g., prompted for issuance in act 506), the method (e.g., 500) further includes: prompting (e.g., in act 501) the in-patient care practitioner (e.g., hospitalist) to select at least one of the several common medical diagnoses, forming an IP-identified diagnosis, and for each of the several common medical diagnoses, when selected by the in-patient care practitioner as the IP-identified diagnosis, prompting (e.g., in act 502) the in-patient care practitioner to select or enter multiple patient conditions that are pertinent to the IP-identified diagnosis. As used herein, the multiple patient conditions that are entered or selected by the in-patient care practitioner are referred to as IP-observed patient conditions.

In a number of such embodiments, the prompting (e.g., in act 502) of the in-patient care practitioner to select or enter the multiple patient conditions that are pertinent to the IP-identified diagnosis: reminds the in-patient care practitioner to measure or evaluate the multiple patient conditions that are pertinent to the IP-identified diagnosis for assurance of quality patient care, establishes a record of the IP-observed patient conditions for future reference for care of the patient, and increases probability that sufficient patient conditions are evaluated and recorded to support third-party payment for treatment of the IP-identified diagnosis. Again, once prompted in act 502, the practitioner may record observations already made, examine the patient, order tests, enter the patient conditions into the computer, or a combination thereof, for example.

Even further, in some embodiments, the prompting of the in-patient care practitioner to select or enter the multiple patient conditions that are pertinent to the IP-identified diagnosis (e.g., act 502) establishes a standard of care for evaluation of the multiple patient conditions for the in-patient care practitioner for the IP-identified diagnosis. Thus, if the in-patient care practitioner evaluates all of the multiple patient conditions that are identified in act 502, then the in-patient care practitioner will have done what is expected of him for that IP-identified diagnosis. Further, the in-patient care practitioner entering such patient conditions into the system provides evidence that the in-patient care practitioner did what was expected of him for that IP-identified diagnosis. On the other hand, if the in-patient care practitioner does not evaluate all of the multiple patient conditions that are identified (e.g., in act 502), then the in-patient care practitioner will not have done what was expected of him for that IP-identified diagnosis, and the record will so indicate. Further, the hospital, or other controlling entity, can control the level of care provided by different healthcare practitioners, can make adjustments when appropriate, and the level of care will be more consistent between different healthcare practitioners.

In some embodiments, the standard of care for the in-patient care practitioner, may be the same, or may differ, from the standard of care for the in-patient care provider, and the patient conditions that are prompted (e.g., in act 502) may reflect such differences. For example, in some embodiments, the in-patient car practitioner may be expected to do a more thorough examination or may be expected to do more testing and therefore may be prompted for a greater number of patient conditions (e.g., in act 502) for a given diagnosis. Further, in some instances, the medical diagnosis selected by the in patient care practitioner may differ from that selected by the emergency department healthcare practitioner, for example, due do different observations, professional experience, or other factors. Different medical diagnoses (e.g., selected in act 501) may result in different patient conditions being prompted in act 502, and different treatment orders in act 503, among other things.

Further, in many such embodiments, for each of the several common medical diagnoses (e.g., prompted for in act 501), when selected by the in-patient care practitioner as the IP-identified diagnosis, the method (e.g., 500) further includes prompting the in-patient care practitioner (e.g., in act 503) to select or enter in-patient care practitioner treatment orders for the IP-identified diagnosis. In a number of these embodiments, for multiple of the several common medical diagnoses (e.g., prompted in act 501), the prompting (e.g., in act 503) of the in-patient care practitioner to select or enter the in-patient care practitioner treatment orders for the IP-identified diagnosis includes prompting the in-patient care practitioner to select or enter an in-patient care practitioner medical prescription. Medication dosages, interactions, or both, may be checked (e.g., in act 504), for instance, as described herein for the emergency department.

Even further, some such embodiments further include determining (e.g., in act 505) whether sufficient patient conditions have been evaluated and recorded to support third-party payment for the level of care in the treatment orders (e.g., admitting the patient to the hospital), and if sufficient patient conditions have not been evaluated and recorded to support third-party payment for the level of care, prompting (e.g., in act 503) the in-patient care practitioner to either evaluate and enter sufficient patient conditions to support third-party payment (e.g., for admitting the patient to the hospital) or to enter an explanation of why the patient needed to be admitted to the hospital (or the level of care need to be implemented) absent sufficient patient conditions to support third-party payment for that level of care. In a number of embodiments, such a method (e.g., 500) further includes an act of prompting the in-patient care practitioner to issue the in-patient care practitioner treatment orders for the IP-identified diagnosis (e.g., act 506).

In particular embodiments, such a method (e.g., 500) can further include automatically comparing the IP-identified diagnosis to the ED-identified diagnosis (e.g., in act 509) and alerting (e.g., in that act or in act 507) if the IP-identified diagnosis is sufficiently different than the ED-identified diagnosis. Further, in some embodiments, the method (e.g., 500) can further include acts of: automatically comparing the IP-observed patient conditions to the ED-observed patient conditions (e.g., in act 509, both patient conditions being prompted to be entered in act 502) and alerting (e.g., in that act or in act 507) if the IP-observed patient conditions are sufficiently different than the ED-observed patient conditions. In various embodiments, act 509 can be used as a teaching tool for the emergency department healthcare practitioner, so they will know whether their initial diagnosis was correct, as a performance evaluation tool to evaluate whether the emergency department healthcare practitioner is making accurate diagnoses, or as a way of evaluating whether additional patient conditions should be prompted for (e.g., in act 502) and evaluated to distinguish between different diagnoses that can otherwise be confused, as examples.

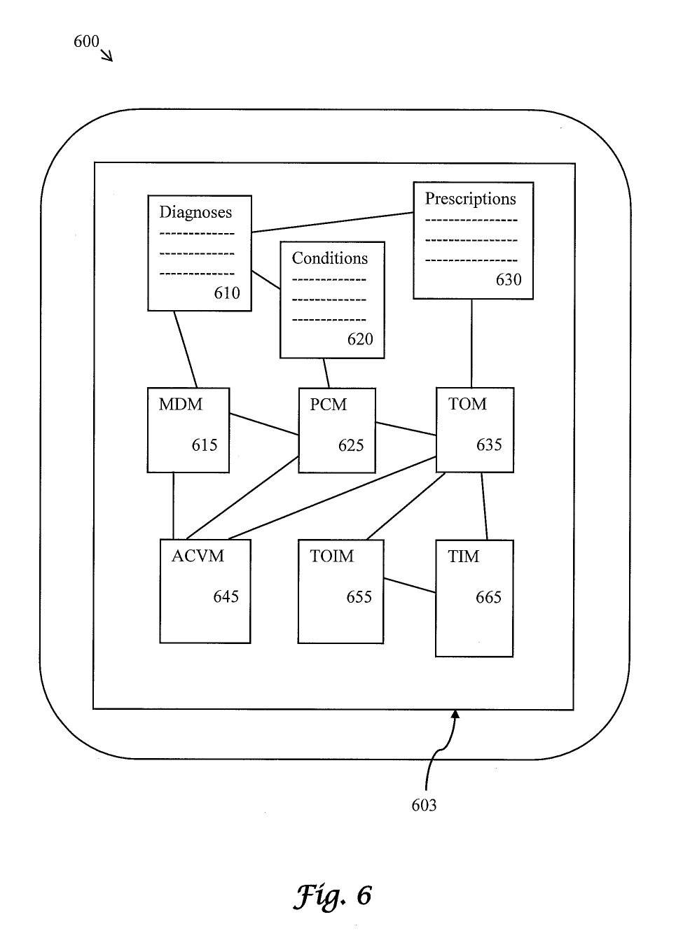

FIG. 6 illustrates an example of an apparatus 600 for managing patient care through at least one emergency department, for example, of at least one hospital. In the embodiment illustrated, apparatus 600 includes, for example, computer 601. Various embodiments include at least one computer, for example, 1, 2, 3, 4, or more computers containing various machine-readable instructions. In the embodiment illustrated, computer 601 includes machine-readable instructions 603. Computer 601 can be or include a tablet computer, for example, or can be or include a laptop computer, a desktop computer, a server, a mainframe computer, a smart phone, or a combination thereof (e.g., one or more each of a combination thereof), as examples, and machine-readable instructions 603 can be stored, located, or operating on or through one or more such computers. In various embodiments, computer 601 can include a microprocessor, user interface (e.g., display, screen, keypad, touch screen, etc.), memory, operating system, software, etc., In particular embodiments, for example, machine-readable instructions 603 can be stored on one or more servers and can be accessed by a tablet computer (e.g., 601) via a network, for instance, the Internet.

In the embodiment shown, machine-readable instructions 603 include list 610 of several common medical diagnoses for presentation to a healthcare practitioner, such as an emergency department healthcare practitioner (e.g., via computer 601). Further, in the embodiment illustrated, machine-readable instructions 603 include, for instance, for each of the several common medical diagnoses on list 610, list 620 of multiple pertinent patient conditions for presentation (e.g., to the emergency department healthcare practitioner). Although one list 620 is shown, in a number of embodiments, a different list 620 is maintained for each of the several common medical diagnoses on list 610. In some embodiments, however, some of the several common medical diagnoses on list 610 may have some or all of the same multiple pertinent patient conditions for presentation to the (e.g., emergency department) healthcare practitioner (e.g., items on list 620).

In a number of embodiments, the list 620 of multiple pertinent patient conditions for presentation to the (e.g., emergency department) healthcare practitioner, e.g., for each of the several common medical diagnoses on list 610, is selected so that evaluation and documentation of the multiple pertinent patient conditions (e.g., on list 620) for each of the medical diagnoses (e.g., on list 610) can (e.g., if the multiple pertinent patient conditions on list 620 have particular values) support third-party payment for treatment thereof (i.e., treatment of the particular medical diagnosis selected from list 610). Further, in the embodiment shown, apparatus 600, or machine-readable instructions 603 include, (e.g., for each of the several common medical diagnoses), a list 630 of alternative medication prescriptions, for instance, for each of the several common medical diagnoses (e.g., on list 610) for presentation to the (e.g., emergency department) healthcare practitioner. Such a presentation can be made, for example, on computer 601. Further, although one list 630 is shown, in a number of embodiments, a different list 630 is maintained for each of the several common medical diagnoses on list 610. In some embodiments, however, some of the several common medical diagnoses on list 610 may have some or all of the same alternative medication prescriptions for presentation to the (e.g., emergency department) healthcare practitioner (e.g., medications on list 630).

Further, in the embodiment shown, apparatus 600 or machine-readable instructions 603 include medical diagnosis module 615 that presents list 610 of several common medical diagnoses to the (e.g., emergency department) healthcare practitioner and that inputs from the (e.g., emergency department) healthcare practitioner an (e.g., ED-identified) diagnosis (e.g., via computer 601). Even further, in this particular embodiment, apparatus 600 or machine-readable instructions 603 include patient conditions module 625 that presents (e.g., via computer 601) the list 620 of multiple pertinent patient conditions to the (e.g., emergency department) healthcare practitioner for the (e.g., ED-identified) diagnosis after the (e.g., emergency department) healthcare practitioner has selected or input the (e.g., ED-identified) diagnosis into medical diagnosis module 615. In various embodiments, the patient conditions module (e.g., 625) inputs from the (e.g., emergency department) healthcare practitioner the multiple pertinent patient conditions for the (e.g., ED-identified) diagnosis (e.g., input via module 615). Further still, in the embodiment shown, apparatus 600 or machine-readable instructions 603 include (e.g., ED) treatment order module 635 that presents list of alternative medication prescriptions 630 to the (e.g., emergency department) healthcare practitioner for the (e.g., ED-identified) diagnosis (e.g., presented and input via module 615) after the (e.g., emergency department) healthcare practitioner has input (e.g., via module 615) the (e.g., ED-identified) diagnosis (e.g., from list 610) into medical diagnosis module 615.

In various embodiments, (e.g., ED) treatment order module 635 prompts the (e.g., emergency department) healthcare practitioner for selection between the alternative medication prescriptions (e.g., in list 630), (e.g., ED) treatment order module 635 inputs from the (e.g., emergency department) healthcare practitioner (e.g., ED) treatment orders for the (e.g., ED) identified diagnosis, or both. Further, in a number of embodiments, the (e.g., ED) treatment orders include an (e.g., ED) medication order, for example, indicating whether or not to administer a selection from list 630 of alternative medication prescriptions. Even further, in certain embodiments, (e.g., ED) treatment order module 635 suggests to the (e.g., emergency department) healthcare practitioner a dosage for the (e.g., ED) medication order or for each of the alternative medication prescriptions (e.g., on list 630) for use in the (e.g., ED) treatment orders for the ED-identified diagnosis. Further still, in a number of embodiments, the (e.g., ED) treatment orders input from the (e.g., emergency department) healthcare practitioner through the (e.g., ED) treatment order module 635 include an admission order indicating whether or not to admit the patient to the hospital for the (e.g., ED) identified diagnosis. Some embodiments can include both a medication order and an admission order in the treatment order.

Moreover, in the embodiment shown, apparatus 600 or machine-readable instructions 603 include admissions criteria verification module 645 which, when the (e.g., ED) treatment orders for the (e.g., ED) identified diagnosis include admitting the patient to the hospital, evaluates whether sufficient (e.g., ED) observed patient conditions (e.g., from list 620) have been evaluated and recorded (e.g., via module 625) to support third-party payment for admitting the patient to the hospital. In certain embodiments, if sufficient (e.g., ED) observed patient conditions have not been evaluated and recorded to support third-party payment for admitting the patient to the hospital, admissions criteria verification module 645 prompts the (e.g., emergency department) healthcare practitioner to evaluate and enter sufficient ED-observed patient conditions to support third-party payment for admitting the patient to the hospital. In particular embodiments, admissions criteria verification module 645 gives the healthcare practitioner the alternative option to enter an explanation of why the patient needs to be admitted to the hospital absent sufficient (e.g., ED) observed patient conditions to support third-party payment for admitting the patient to the hospital.

Even further, in the embodiment illustrated, apparatus 600 or machine-readable instructions 603 include (e.g., ED) treatment order issuance module 655 that provides for the (e.g., emergency department) healthcare practitioner to issue the (e.g., ED) treatment orders for the (e.g., ED) identified diagnosis. In various embodiments, the healthcare practitioner can issue the treatment orders by electronically signing them, by clicking on an “issue treatment orders” button or icon, or the like. In some embodiments, module 655 prompts the healthcare practitioner to verify (e.g., by clicking on a button or icon) that he or she wishes to issue the treatment orders. Further, in some embodiments, module 655 requires entering of a password, user identification, or code to issue the treatment orders. In some embodiments, issuance of treatment orders requires authorization by a superior healthcare practitioner, as another example.

Further still, in the embodiment shown, apparatus 600 or machine-readable instructions 603 include (e.g., ED) treatment implementation module 665. In a number of embodiments, when the (e.g., ED) treatment orders for the (e.g., ED) identified diagnosis include admitting the patient to the hospital, and the emergency department healthcare practitioner has issued the (e.g., ED) treatment orders for the (e.g., ED) identified diagnosis through (e.g., ED) treatment order issuance module 655, treatment implementation module 665 automatically contacts another healthcare practitioner, such as an in-patient care practitioner, for example, at the hospital, for instance, through at least one communications network. In various embodiments, treatment implementation module 665, advises the (e.g., in-patient care practitioner) of the (e.g., ED) identified diagnosis, the (e.g., ED) treatment orders, or both. Even further still, in some embodiments, (e.g., ED) treatment implementation module 665 automatically initiates a process to find a bed for the patient, for example, at the hospital.

In particular embodiments, when the (e.g., ED) treatment orders (e.g., selected or entered via module 635) for the (e.g., ED) identified diagnosis include admitting the patient to the hospital, and the (e.g., emergency department) healthcare practitioner has issued the (e.g., ED) treatment orders for the (e.g., ED) identified diagnosis through (e.g., ED) treatment order issuance module 655, (e.g., ED) treatment implementation module 665 also follows up (e.g., at a predetermined time) on the process to find the bed for the patient at the hospital. Examples of such following up on the process of finding a bed are described herein.

In some embodiments, an in-patient care practitioner can use apparatus 600, or a similar or identical apparatus, in addition to or rather than an emergency department healthcare practitioner. In certain embodiments, the apparatus can be customized for the in-patient care practitioner or for the emergency department healthcare practitioner, or both, for example, with one or more different (e.g., partially different) lists 610, 620, 630, or a combination thereof. Some embodiments have analogous elements, lists, modules, or a combination thereof, to those shown in FIG. 6, for example. In particular embodiments, the apparatus may be configured so that the in-patient care practitioner can select or input an IP-identified diagnosis, IP-observed patient conditions, and IP treatment orders (e.g., IP medication orders), for example. Further, in some embodiments, the lists, modules, or both, shown in FIG. 6, can be combined or can be divided into more or different lists, modules, or both. Further still, in some embodiments, other modules, lists, or both, such as those described herein, can be combined with part or all of apparatus 600. Further, various modules and other elements described for apparatus can have some or all features described herein for other modules or elements.

In some embodiments, machine-readable instructions 603 can be stored remotely from computer 601, and computer 601 can access machine-readable instructions 603 via a network such as the Internet. In some embodiments, machine-readable instructions 603, or similar versions thereof, can be used by different healthcare practitioners, for example, in different hospitals. Further, in some embodiments, machine-readable instructions 603 can be provided to one or more hospitals as a service, for example, in exchange for a monthly fee, or can be provided as a service, for instance, in conjunction with providing one or more healthcare practitioners (e.g., emergency department physicians or hospitalists). In other embodiments, however machine-readable instructions 603 can be owned by, licensed to, or controlled by, (or a combination thereof) the hospital, for example, in competition with other hospitals. Still further, in some embodiments, machine-readable instructions 603 can be provided or controlled by a governmental entity, for example, as a means to assure that all healthcare providers meet a minimum standard of care, as a means to control costs, or both. Even further still, in some embodiments, machine-readable instructions 603 can be provided or controlled by an insurance company, as another example.

It should be appreciated that various of the above-disclosed and other features and functions, or alternatives thereof, may be desirably combined into many other different systems and applications. Also, various alternatives, modifications, variations or improvements therein may be made by those skilled in the art which are also anticipated herein. Various embodiments of the subject matter described herein include various combinations of the acts, structure, components, and features described herein, shown in the drawings, or known in the art. Moreover, certain procedures may include acts such as obtaining or providing various structural components described herein, and obtaining or providing components that perform functions described herein. Furthermore, various embodiments include advertising and selling products that perform functions described herein, that contain structure described herein, or that include instructions to perform functions described herein, as examples. Such products may be obtained or provided through distributors, dealers, or over the Internet, for instance. The subject matter described herein also includes various means for accomplishing the various functions or acts described herein or apparent from the structure and acts described.

What is claimed is:

1. A computer implemented method of managing patient care through an emergency department of a hospital, the method comprising machine-readable instructions that, when executed, perform, in any order, at least the acts of:
using the computer, prompting an emergency department healthcare practitioner to select at least one of several common medical diagnoses for a patient, forming an ED-identified diagnosis;
for each of the several common medical diagnoses, when selected by the emergency department healthcare practitioner to form the ED-identified diagnosis, prompting the emergency department healthcare practitioner to select or enter multiple patient conditions that are pertinent to the ED-identified diagnosis, wherein the multiple patient conditions that are entered or selected by the emergency department healthcare practitioner are ED-observed patient conditions, and wherein the prompting of the emergency department healthcare practitioner to select or enter the multiple patient conditions that are pertinent to the ED-identified diagnosis: reminds the emergency department healthcare practitioner to measure or evaluate the multiple patient conditions that are pertinent to the ED-identified diagnosis for assurance of quality patient care, establishes a record of the ED-observed patient conditions for future reference for care of the patient, and increases probability that sufficient patient conditions are evaluated and recorded to support third-party payment for treatment of the ED-identified diagnosis;
for each of the several common medical diagnoses, when selected by the emergency department healthcare practitioner as the ED-identified diagnosis, prompting the emergency department healthcare practitioner to select or enter ED treatment orders for the ED-identified diagnosis, wherein for multiple of the several common medical diagnoses, the prompting of the emergency department healthcare practitioner to select or enter the ED treatment orders for the ED-identified diagnosis comprises: prompting the emergency department healthcare practitioner to select or enter an ED medical prescription, and prompting the emergency department healthcare practitioner to select a level of care for the patient in the hospital;
when the ED treatment orders for the ED-identified diagnosis include admitting the patient to the hospital, determining whether sufficient ED-observed patient conditions have been evaluated and recorded to support third-party payment for admitting the patient to the hospital, and if sufficient ED-observed patient conditions have not been evaluated and recorded to support third-party payment for admitting the patient to the hospital, prompting the emergency department healthcare practitioner to either evaluate and enter sufficient ED-observed patient conditions to support third-party payment for admitting the patient to the hospital or to enter an explanation of why the patient needs to be admitted to the hospital absent the sufficient ED-observed patient conditions to support third-party payment for admitting the patient to the hospital;
prompting the emergency department healthcare practitioner to issue the ED treatment orders for the ED-identified diagnosis;
when the ED treatment orders for the ED-identified diagnosis include admitting the patient to the hospital, and the emergency department healthcare practitioner has issued the ED treatment orders for the ED-identified diagnosis, automatically contacting an in-patient care practitioner at the hospital, through at least one communications network, and advising the in-patient care practitioner of the ED-identified diagnosis and the ED treatment orders; and
when the ED treatment orders for the ED-identified diagnosis include admitting the patient to the hospital, and the emergency department healthcare practitioner has issued the ED treatment orders for the ED-identified diagnosis, automatically initiating a process, through at least one communications network, to find a bed for the patient at the hospital.

2. The method of claim 1 wherein, when the ED treatment orders for the ED-identified diagnosis include admitting the patient to the hospital, and the emergency department healthcare practitioner has issued the ED treatment orders for the ED-identified diagnosis, the method further comprises acts, using the computer, of finding and assigning a bed for the patient based on at least one of the ED-identified diagnosis or the ED-observed patient conditions.

3. The method of claim 1 wherein, when the ED treatment orders for the ED-identified diagnosis include admitting the patient to the hospital, and the emergency department healthcare practitioner has issued the ED treatment orders for the ED-identified diagnosis, the method further comprises an act of following up at a predetermined time on the process to find the bed for the patient at the hospital.

4. The method of claim 3 wherein the act of automatically initiating the process to find the bed for the patient at the hospital comprises automatically contacting a hospital administrator to request the bed, and wherein the act of following up at a predetermined time on the process to find the bed for the patient at the hospital comprises automatically contacting a superior of the hospital administrator to request the bed after the predetermined time.

5. The method of claim 1 wherein, for a plurality of the several common medical diagnoses, the act of prompting the emergency department healthcare practitioner to select or enter an ED medical prescription comprises prompting the emergency department healthcare practitioner to select or enter an ED medication prescription.

6. The method of claim 5 wherein, when the ED treatment orders for the ED-identified diagnosis include admitting the patient to the hospital and administering the ED medication prescription, and the emergency department healthcare practitioner has issued the ED treatment orders for the ED-identified diagnosis, the method further comprises an act of automatically communicating the ED medication prescription to a pharmacy for the hospital.

7. The method of claim 5 further comprising an act of prompting the emergency department healthcare practitioner to select the ED medication prescription from multiple medication alternatives, wherein the multiple medication alternatives are each commonly prescribed for the ED-identified diagnosis.

8. The method of claim 5 further comprising an act of prompting the emergency department healthcare practitioner to select the ED medication prescription from multiple medication alternatives, wherein the multiple medication alternatives are each hospital-preferred medications for the ED-identified diagnosis.

9. The method of claim 7 further comprising at least one of:
suggesting to the emergency department healthcare practitioner a dosage for the ED medication prescription or for each of the multiple medication alternatives; or
prompting the emergency department healthcare practitioner to select or enter a dosage for the ED medication prescription; evaluating whether the dosage selected or entered by the emergency department healthcare practitioner for the ED medication prescription is within a recommended dosage range for the ED medication prescription; and alerting if the dosage entered by the emergency department healthcare practitioner for the ED medication prescription is not within the recommended dosage range for the ED medication prescription.

10. The method of claim 7 further comprising acts of: prompting the emergency department healthcare practitioner to select or enter a body weight of the patient; automatically calculating a dosage or a dosage range for the ED medication prescription or for the multiple medication alternatives using the body weight of the patient; and communicating the dosage or the dosage range for the ED medication prescription or for the multiple medication alternatives to the emergency department healthcare practitioner for use in determining the ED treatment orders for the ED-identified diagnosis.

11. The method of claim 7 further comprising acts of: using the computer, identifying other medications that the patient is taking; automatically checking for risk of negative interactions between the other medications that the patient is taking and the ED medication prescription or the multiple medication alternatives; and alerting if the risk of negative interactions between the other medications that the patient is taking and the ED medication prescription or the multiple medication alternatives is considered to be excessive.

12. The method of claim 1 wherein, when the ED treatment orders for the ED-identified diagnosis include admitting the patient to the hospital, and the emergency department healthcare practitioner has issued the ED treatment orders for the ED-identified diagnosis, the act of automatically contacting the in-patient care practitioner at the hospital further comprises advising the in-patient care practitioner of the ED-observed patient conditions selected or entered by the emergency department healthcare practitioner.

13. The method of claim 1 wherein, for a plurality of the several common medical diagnoses, the act of prompting the emergency department healthcare practitioner to select or enter an ED medical prescription comprises prompting the emergency department healthcare practitioner to select or enter at least one medical test.

14. The method of claim 1 wherein, when the ED treatment orders for the ED-identified diagnosis includes admitting the patient to the hospital, and the emergency department healthcare practitioner has issued the ED treatment orders for the ED-identified diagnosis, the method further comprises:
prompting the in-patient care practitioner to select at least one of the several common medical diagnoses, forming an IP-identified diagnosis;
for each of the several common medical diagnoses, when selected by the in-patient care practitioner as the IP-identified diagnosis, prompting the in-patient care practitioner to select or enter multiple patient conditions that are pertinent to the IP-identified diagnosis, wherein the multiple patient conditions that are entered or selected by the in-patient care practitioner are IP-observed patient conditions, and wherein the prompting of the in-patient care practitioner to select or enter the multiple patient conditions that are pertinent to the IP-identified diagnosis: reminds the in-patient care practitioner to measure or evaluate the multiple patient conditions that are pertinent to the IP-identified diagnosis for assurance of quality patient care, establishes a record of the IP-observed patient conditions for future reference for care of the patient, and increases probability that sufficient patient conditions are evaluated and recorded to support third-party payment for treatment of the IP-identified diagnosis;
for each of the several common medical diagnoses, when selected by the in-patient care practitioner as the IP-identified diagnosis, prompting the in-patient care practitioner to select or enter in-patient care practitioner treatment orders for the IP-identified diagnosis, wherein for multiple of the several common medical diagnoses, the prompting of the in-patient care practitioner to select or enter the in-patient care practitioner treatment orders for the IP-identified diagnosis comprises prompting the in-patient care practitioner to select or enter an in-patient care practitioner medical prescription;
determining whether sufficient patient conditions have been evaluated and recorded to support third-party payment for admitting the patient to the hospital, and if sufficient patient conditions have not been evaluated and recorded to support third-party payment for admitting the patient to the hospital, prompting the in-patient care practitioner to either evaluate and enter sufficient patient conditions to support third-party payment for admitting the patient to the hospital or to enter an explanation of why the patient needed to be admitted to the hospital absent sufficient patient conditions to support third-party payment for admitting the patient to the hospital; and
prompting the in-patient care practitioner to issue the in-patient care practitioner treatment orders for the IP-identified diagnosis.

15. The method of claim 14 further comprising acts of: automatically comparing the IP-identified diagnosis to the ED-identified diagnosis and alerting if the IP-identified diagnosis is sufficiently different than the ED-identified diagnosis.

16. The method of claim 14 further comprising acts of: automatically comparing the IP-observed patient conditions to the ED-observed patient conditions and alerting if the IP-observed patient conditions are sufficiently different than the ED-observed patient conditions.

17. The method of claim 1 wherein the prompting of the emergency department healthcare practitioner to select or enter the multiple patient conditions that are pertinent to the ED-identified diagnosis establishes a standard of care for evaluation of the multiple patient conditions in the emergency department for the ED-identified diagnosis.

18. An apparatus for managing patient care through at least one emergency department of at least one hospital, the apparatus comprising at least one computer containing machine-readable instructions comprising:
a list of several common medical diagnoses for presentation to an emergency department healthcare practitioner;
for each of the several common medical diagnoses, a list of multiple pertinent patient conditions for presentation to the emergency department healthcare practitioner wherein evaluation and documentation of the multiple pertinent patient conditions for each of the medical diagnoses can support third-party payment for treatment thereof;
for each of the several common medical diagnoses, a list of alternative medication prescriptions for each of the several common medical diagnoses for presentation to the emergency department healthcare practitioner;
a medical diagnosis module that presents the list of several common medical diagnoses to the emergency department healthcare practitioner and that inputs from the emergency department healthcare practitioner an ED-identified diagnosis;
a patient conditions module that presents the list of multiple pertinent patient conditions to the emergency department healthcare practitioner for the ED-identified diagnosis after the emergency department healthcare practitioner has input the ED-identified diagnosis into the medical diagnosis module, wherein the patient conditions module inputs from the emergency department healthcare practitioner the multiple pertinent patient conditions for the ED-identified diagnosis;
an ED treatment order module that presents the list of alternative medication prescriptions to the emergency department healthcare practitioner for the ED-identified diagnosis after the emergency department healthcare practitioner has input the ED-identified diagnosis into the medical diagnosis module, wherein:
the ED treatment order module prompts the emergency department healthcare practitioner for selection between the alternative medication prescriptions;
the ED treatment order module inputs from the emergency department healthcare practitioner ED treatment orders for the ED-identified diagnosis;
the ED treatment orders comprise an ED medication order indicating whether or not to administer a selection from the list of alternative medication prescriptions; and
the ED treatment orders input from the emergency department healthcare practitioner through the ED treatment order module also comprise an admission order indicating whether or not to admit the patient to the hospital for the ED-identified diagnosis;
an admissions criteria verification module which, when the ED treatment orders for the ED-identified diagnosis include admitting the patient to the hospital, evaluates whether sufficient ED-observed patient conditions have been evaluated and recorded to support third-party payment for admitting the patient to the hospital, and if sufficient ED-observed patient conditions have not been evaluated and recorded to support third-party payment for admitting the patient to the hospital, that prompts the emergency department healthcare practitioner to evaluate and enter sufficient ED-observed patient conditions to support third-party payment for admitting the patient to the hospital or to enter an explanation of why the patient needs to be admitted to the hospital absent sufficient ED-observed patient conditions to support third-party payment for admitting the patient to the hospital;
an ED treatment order issuance module that provides for the emergency department healthcare practitioner to issue the ED treatment orders for the ED-identified diagnosis; and
an ED treatment implementation module that, when the ED treatment orders for the ED-identified diagnosis include admitting the patient to the hospital, and the emergency department healthcare practitioner has issued the ED treatment orders for the ED-identified diagnosis through the ED treatment order issuance module, automatically contacts a in-patient care practitioner at the hospital, through at least one communications network, and advises the in-patient care practitioner of the ED-identified diagnosis and the ED treatment orders, and automatically initiates a process to find a bed for the patient at the hospital.

19. The apparatus of claim 18 wherein, when the ED treatment orders for the ED-identified diagnosis include admitting the patient to the hospital, and the emergency department healthcare practitioner has issued the ED treatment orders for the ED-identified diagnosis through the ED treatment order issuance module, the ED treatment implementation module also follows up at a predetermined time on the process to find the bed for the patient at the hospital.

20. The apparatus of claim 18 wherein the ED treatment order module suggests to the emergency department healthcare practitioner a dosage for the ED medication order or for each of the alternative medication prescriptions for use in the ED treatment orders for the ED-identified diagnosis.
